(19) United States
(12) Patent Application Publication
(10) Pub. No.: US 2010/0117988 A1
(43) Pub. Date: May 13, 2010

(54) OPTICAL ELEMENT AND TOUCH SENSOR

(76) Inventors: Adrian Marc Simon JACOBS, Oxford (GB); Harry Garth Walton, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/269,107

(22) Filed: Nov. 12, 2008

(51) Int. Cl. G06F 3/042

(52) U.S. Cl. 345/175

(57) ABSTRACT

A touch sensor for a touch display is provided which includes an optical element including at least one electrically conductive layer, the at least one electrically conductive layer being partially reflective and partially transmissive with respect to incident light; and sensing circuitry electrically coupled to the at least one electrically conductive layer to determine positioning of a finger, hand or other type of pointing device relative to the optical element.

### TECHNICAL FIELD

The present invention relates to an optical element. Such an element may simultaneously function as a partial reflector and as a touch sensor. The present invention also relates to a display system including such an element. Such a display may be used, for example, to provide an impression of depth or changed depth. Such a display may, for example, be used in information display applications including computer-aided design, games and television and in applications where warnings or other messages are required to stand out from a background. The optical element may be advantageously applied in any such system as requires a user touch input, to provide an additional touch function integrated with the display system.

### BACKGROUND OF THE INVENTION

It is known in display systems for a display that requires user interaction to incorporate an additional transparent touch sensor, for example in control systems, mobile devices such as phones and PDAs. However, such devices generally have a flat surface and provide no feedback to the user that the sensor has been successfully touched.

It is further known that there are displays that can provide added realism by simultaneously producing images in multiple depth planes. These can provide apparent touch feedback by moving images between planes.

FIG. 1 of the accompanying drawings illustrates a display type for displaying background and foreground images with different image depths as described in GB 2 437 553. It may be seen that a combination of a partial mirror and other extra optical elements added to the display produce the two different image planes. FIG. 2 illustrates an application of such a display wherein an image of a button appears to move downwards into a different image plane thus giving the impression of a physical button moving and hence providing feedback to the users touch. However, such a display will require an additional touch sensor to be added on top, thus adding cost and thickness and reducing optical performance.

FIG. 3 of the accompanying drawings illustrates a display of the type disclosed in US2008/62148 for providing a touch function in a TFT LCD display. Although it uses an existing conducting layer to provide the touch function, a further additional conductive layer must be added. This adds cost, as well as adding complexity to the design of the LCD control electronics.

FIG. 4 of the accompanying drawings illustrates a display component of the type disclosed in U.S. Pat. No. 6,765,629. A touch panel is integrated into the top polariser of an LCD display. However, this is merely a mechanical integration of two functionally separate components and as such does not provide substantial improvement over a separate touch panel.

FIG. 5 of the accompanying drawings illustrates a display of the type disclosed in US2005/0231487. This shows a touch panel integrated with an LCD. Typically an LCD will comprise two glass substrates and the touch panel will also comprise two glass substrates, giving four in total. This reference describes a method to eliminate one substrate by using one layer common to both components. However, this still increases the size and weight compared to the base display. Further, LCDs are typically manufactured by forming many units on a single large “motherglass” substrate, then assembling the large substrates and finally cutting the assembled substrates into separate units. If three substrates were simultaneously assembled in such a manner then there would be substantial difficulty in cutting into separate units as the central substrate could not easily be scribed and cut.

FIG. 6 of the accompanying drawings illustrates a display type that employs a partial mirror as an additional component to provide added function as described in GB 2 443 650. In this case it provides a device that is switchable between a display mode, in which the underlying LCD is visible, and a mirror mode in which ambient light is reflected and it functions as a plane mirror. However, such a device does not have any touch function.

FIG. 7 of the accompanying drawings illustrates a display type for producing an image of curved appearance, for example for advertising or entertainment purposes, as described in GB Application No. 0710407.8. It is similar in function to the display illustrated in FIG. 1 in that the image plane is shifted to a different apparent position. However, in this case at least one of the partial reflectors is non-planar (i.e. curved). This can result in the image plane appearing curved, without the complexity of creating a curved LCD. However, such a device does not have any touch function nor describes issues relating to forming a curved touch screen.

There is a requirement for various display systems utilising a partial mirror to have a touch function to provide additional usability. None of the above described approaches are able to provide such in an integrated method, thus adding cost, thickness/weight and complexity.

### SUMMARY OF THE INVENTION

According to a first aspect of the invention, there is provided an optical element having combined function as a partial mirror and as a touch sensor.

Such a sensor will determine the spatial location of a finger or other pointing device brought into close proximity.

The element may comprise one or more spatially-patterned electrically conducting layers.

The layer may be metallic, for example aluminium or silver.

The transmittance and reflectance of the element may be principally determined by the proportion of the surface area that is covered with such a layer.

The transmittance (T) and reflectance (R) of the element may both be in the range 0.2-0.8, subject to the equation below where A is absorption:

R+T+A=1

The layer may comprise a randomised pattern of conducting and non-conducting regions. Such a pattern may be arranged to avoid any unwanted optical artefacts such as Moire fringes or diffraction effects.

The layer may comprise a regular array of conducting and non-conducting lines. Such an array may have a pitch which is less than 1 micron. Such a layer may reflect plane polarised light with polarisation axis parallel to such an array, and transmit light polarised orthogonal to it. As such it may function as a reflective polariser. Such an element therefore constitutes a combined reflective polariser and touch sensor.

The full area of the sensor may be electrically contiguous or it may be sub-divided into regions electrically insulated from each other. Such regions may be arranged in a regular array or comprise multiple arrays on multiple layers in parallel planes which are electrical insulated from each other.

Touch sensing may be actuated by the presence of a finger or hand, or by materials in contact with the finger/hand such as a glove or stylus or any similar pointing device.

Capacitance sensing methods may be used to determine the location of the pointing device. This may include the “surface capacitance” method wherein the current flowing from the finger to each of the four corners of the sensor is measured to determine the position.

It may further include the “projected capacitance” method wherein the capacitance of a series of discrete conducting elements is monitored, which will be modified by the presence of a finger. Such a method may be advantageous as it is sensitive to close proximity rather than requiring relatively close contact for good operation.

Resistive methods may be used wherein the sensor comprises two spaced apart conducting layers, usually comprising an array of discrete conductors. Changes in resistance are monitored to detect locations where the conducting layers have been brought closer together by the applied pressure from a pointing device.

The touch sensor may provide discrete “buttons”, or provide continuous sensing in one or two dimensions (“slider” or “touchpad”). Some sensing in the third dimension (distance from the sensor plane) may also be possible.

According to a second aspect of the invention, there is provided a display system comprising such an optical element wherein multiple image planes are viewable.

It is thus possible to achieve a multiple depth display with integrated touch function at reduced cost and thickness compared to separate components.

According to a third aspect of the invention, there is provided a display system comprising such an optical element wherein the image plane appears to be non-planar.

According to a fourth aspect of the invention, there is provided a display system comprising such an optical element wherein the system may function switchably either as an image display or as a reflecting mirror.

According to a fifth aspect of the invention, there is provided a reflective or transmissive display system comprising such an optical element wherein the display has an integrated touch sensor.

A touch sensor for a touch display is provided which includes an optical element including at least one electrically conductive layer, the at least one electrically conductive layer being partially reflective and partially transmissive with respect to incident light; and sensing circuitry electrically coupled to the at least one electrically conductive layer to determine positioning of a finger, hand or other type of pointing device relative to the optical element.

The at least one electrically conductive layer may include a randomized pattern of conducting regions and non-conducting regions.

The at least one electrically conductive layer may include a regular array of conducting and non-conducting lines.

The array may have a pitch which is less than 1 micron.

The optical element may reflect plane polarized light with an axis parallel to the array, and transmit light polarized orthogonal to the array.

The at least one electrically conductive layer may be electrically contiguous across an entire area of the at least one electrically conductive layer.

The at least one electrically conductive layer may be subdivided into regions electrically isolated from each other.

The subdivided regions may be arranged in a regular array or comprise multiple arrays on multiple layers in parallel planes electrically isolated from each other.

The optical element may function as a reflective polariser.

The transmittance and reflectance of the at least one electrically conductive layer may each be within the range of 0.2 to 0.8.

The transmittance and reflectance of the at least one electrically conductive layer may each be within the range of 0.4 to 0.6.

The sensing circuitry may be configured to determine position by measuring current with respect to a plurality of different reference locations on the electrically conductive layer.

The sensing circuitry may be configured to determine position by monitoring a capacitance of each of a plurality of electrically isolated regions in the at least one electrically conductive layer.

The optical element may include first and second electrically conductive layers in parallel planes electrically isolated from each other, each of the first and second electrically conductive layers being subdivided into regions electrically isolated from each other, and the sensing circuitry may be configured to determine the position by monitoring at least a capacitance or resistance associated with each of the electrically isolated regions.

A touch display system is provided which includes an image device for providing an image and a touch sensor as described above.

The optical element may be operative in creating multiple image planes.

The optical element may be operative in creating a curved image plane.

The at least one electrically conductive layer may include a spatially-patterned metallic layer.

The at least one electrically conductive layer includes a metallic layer sufficiently thin so as to have a transmittance and reflectance each within the range of 0.4 to 0.6.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention will be further described, by way of example, with reference to the accompanying drawings, in which:

FIG. 1 is a cross-sectional diagrammatic view showing an example of a conventional multiple image depth display;

FIG. 2 is an illustration showing an example of an application of a multiple image depth display of the type shown in FIG. 1;

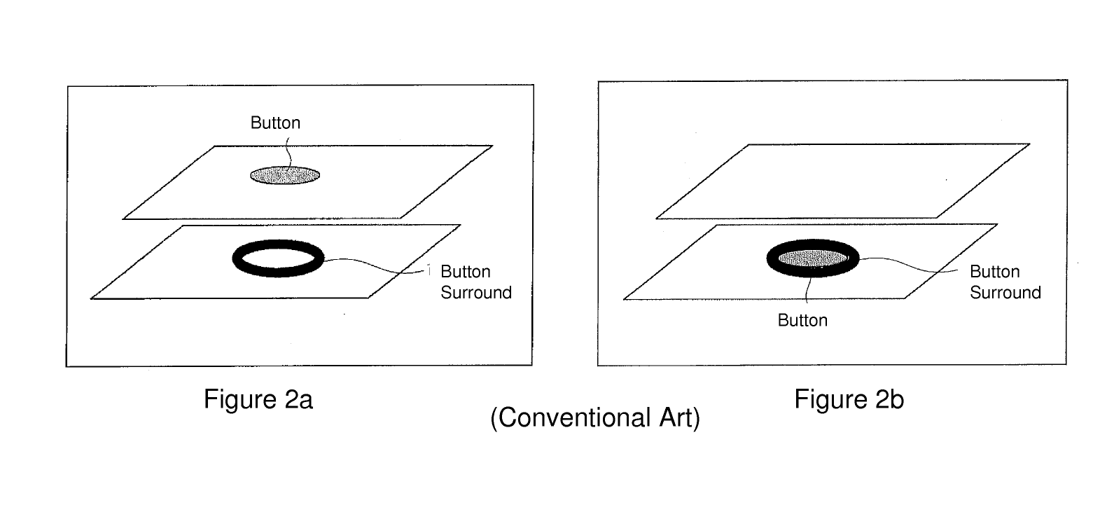

FIG. 3 is a cross-sectional diagrammatic view showing an example of a conventional display incorporating a touch sensor;

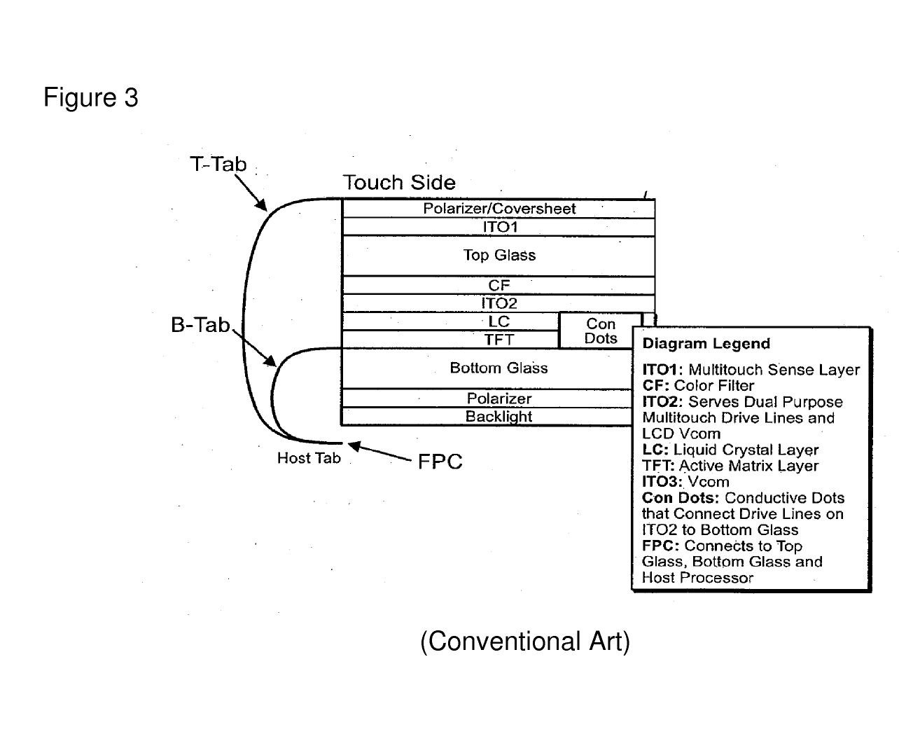

FIG. 4 is a cross-sectional diagrammatic view showing an example of a conventional display incorporating a touch sensor;

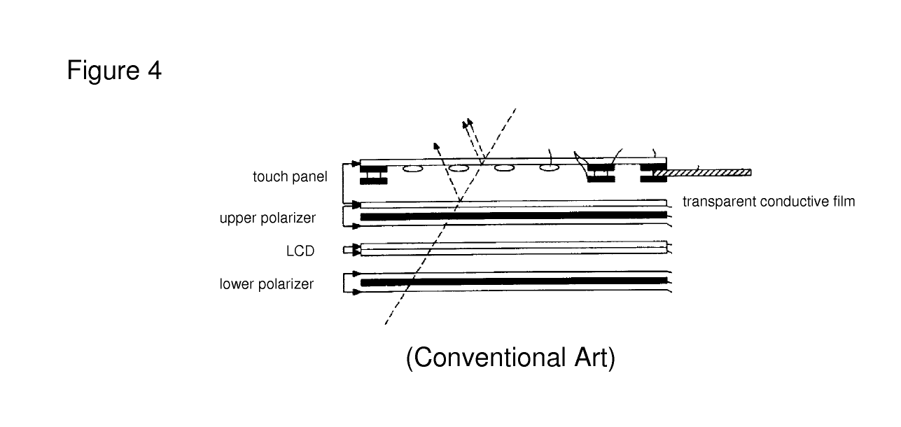

FIG. 5 is a cross-sectional diagrammatic view showing an example of a conventional display incorporating a touch sensor;

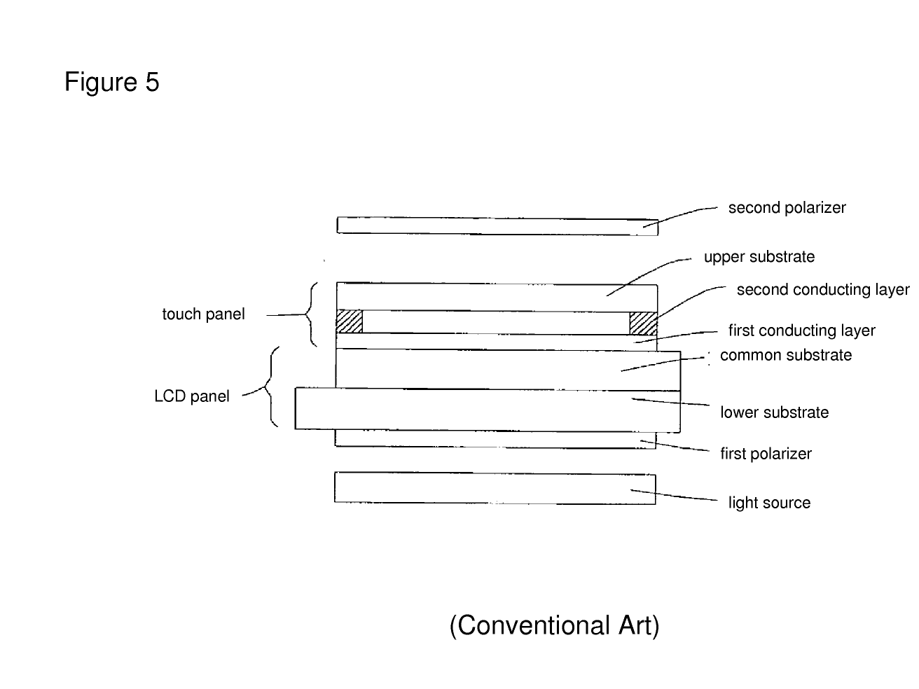

FIG. 6 is a cross-sectional diagrammatic view showing an example of a conventional display with a switchable mirror function;

FIG. 7 is a cross-sectional diagrammatic view showing an example of a conventional display producing an image of curved appearance;

FIG. 8 is a diagram illustrating an element according to a first embodiment of the invention;

FIG. 9 is a diagram illustrating an element according to a second embodiment of the invention;

FIG. 10 is a diagram illustrating an element according to a third embodiment of the invention;

FIG. 11 is a diagram illustrating a possible layout of elements for touch sensing according to the invention;

FIG. 12 is a diagram illustrating a possible layout of elements for touch sensing according to the invention;

FIG. 13 is a diagram illustrating a touch measurement method associated with an element according to the invention;

FIG. 14 is a diagram illustrating a touch measurement method associated with an element according to the invention;

FIG. 15 is a cross-sectional diagrammatic view showing an example of a resistive touch sensor using an element according to the invention;

FIG. 16 is a cross-sectional diagrammatic view showing an example of a multiple image depth display using an element according to the invention;

FIG. 17 is a cross-sectional diagrammatic view showing an example of a multiple image depth display using an element according to the invention;

FIG. 18 is a cross-sectional diagrammatic view showing an example of a display using an element according to the invention;

FIG. 19 is a cross-sectional diagrammatic view showing an example of a display using an element according to the invention;

Like reference numerals refer to like parts throughout the drawings.

### DETAILED DESCRIPTION OF THE INVENTION

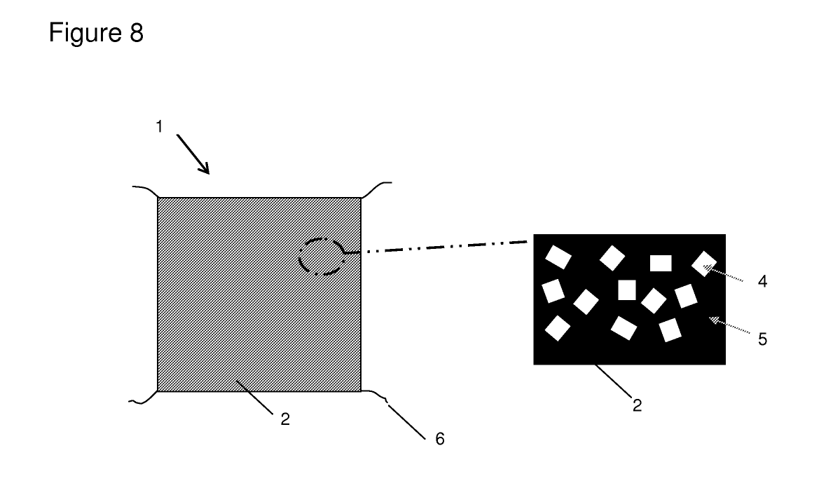

FIG. 8 illustrates an element 1 representing a first and simplest embodiment of the invention. The element 1 comprises an electrically conducting layer 2 formed on a transparent substrate, such as glass or plastic. Such a conducting layer 2 may be formed from any suitable conducting material, for example metallic materials such as Aluminium or Silver, using conventional techniques. The material typically does not cover the whole surface of the substrate i.e. the layer is not continuous but patterned into regions. Regions covered in metal will substantially reflect light, whilst regions without will substantially transmit. As such, averaged across the area, the element overall will constitute a partial reflector for light.

An expanded view of the layer 2 (shown in dotted line) illustrates regions 4 where the conductor is absent and regions 5 where the conductor is present. In this example the absent regions 4 are in the form of rectangles of random distributions with a side length 30 microns. This pattern is useful in avoiding both substantial diffraction effects and any Moire interference effects with over regular structures in a display system. However, it should be understood that the invention is not limited to any particular pattern, although the conducting material should be electrically contiguous.

Such a conducting layer 2 may be formed for example by; depositing aluminium by vacuum sputtering on the substrate; overcoating the layer with a photoresist; UV exposure of the resist through a suitable mask; development of the resist; etching of the exposed metal with a suitable acidic etchant; removal of the remaining resist. Such a method, and many other patterning techniques, are well known to those skilled in the art. A further overcoating of protective material (not shown) may be useful to limit oxidation which reduces reflectivity.

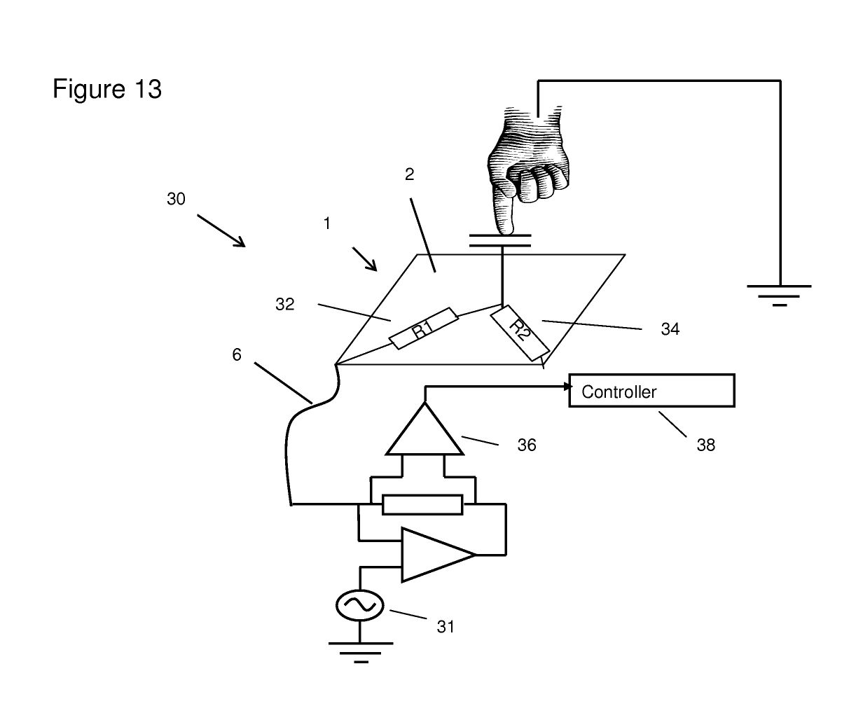

The element 1 further comprises electrical connections 6 at it's four corners in order to provide for touch sensing. Such an element 1 can be combined with known touch capacitance measurement techniques to function as a touch sensor. An example of such measurement techniques is the method known as “surface capacitance” as illustrated in FIG. 13 and described below. Thus, the optical element 1 has a combined function as touch sensor and partial reflector.

The transmittance (T) and reflectance (R) of the element 1 may be principally determined by the proportion of the surface area of layer 2 that is covered with the reflective conducting material (regions 5). If the proportion of the area covered with the reflective conducting material is X and the reflectivity of the conducting material is r then (ignoring reflection/absorption losses in the substrate):

R=r·X

T=1−X

Reflectivities r of >0.9 can be achieved for Aluminium and >0.95 for Silver.

Both R and T may typically be in the range 0.2-0.8 for the element 1, and more preferably in the range 0.4-0.6. However, for many common applications values close to 0.5 are the most useful.

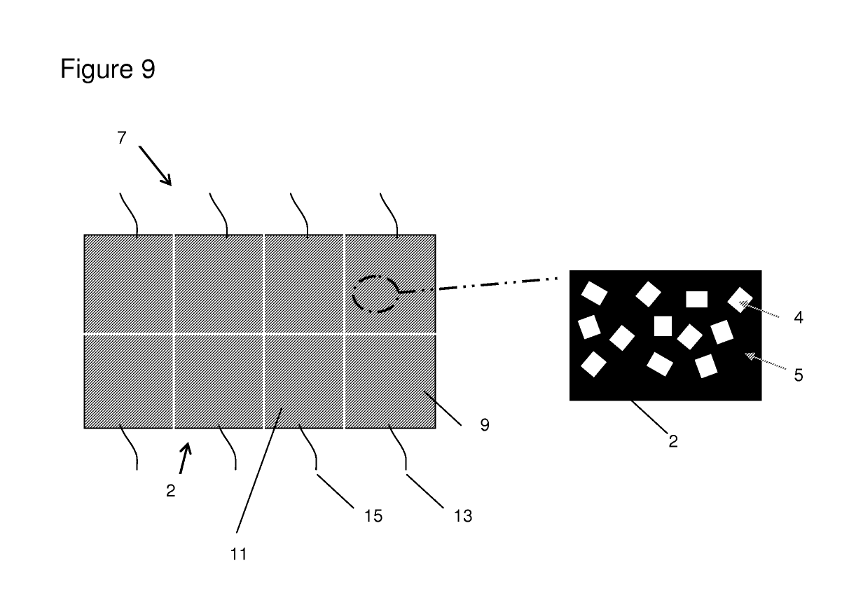

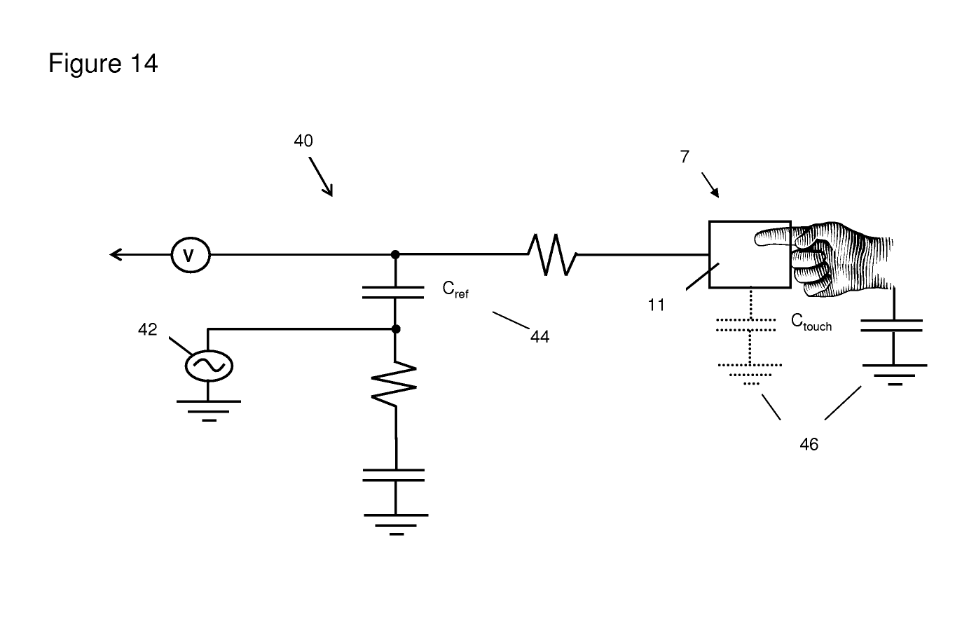

FIG. 9 illustrates an element 7 representing a second embodiment of the invention. This embodiment differs from the embodiment in FIG. 8 in that the conducting layer 2 is split into discrete regions (9 and 11 for example) which are electrically isolated from one another on the underlying substrate. Each of the discrete regions 9, 11, etc. will each have their own electrical connection 13, 15, etc., respectively. Sub-patterning within each discrete region (e.g., as represented by the expanded view) may have the random rectangle form of the embodiment of FIG. 8 with regions 4, 5 or any other form as previously described. Such an arrangement of discrete regions 9, 11, etc. may be advantageous for use with alternate touch sensing methods such as the “projected capacitance” method illustrated in FIG. 14 and described below. Such a method may be advantageous as it is sensitive to close proximity rather than requiring relatively close contact for good operation.

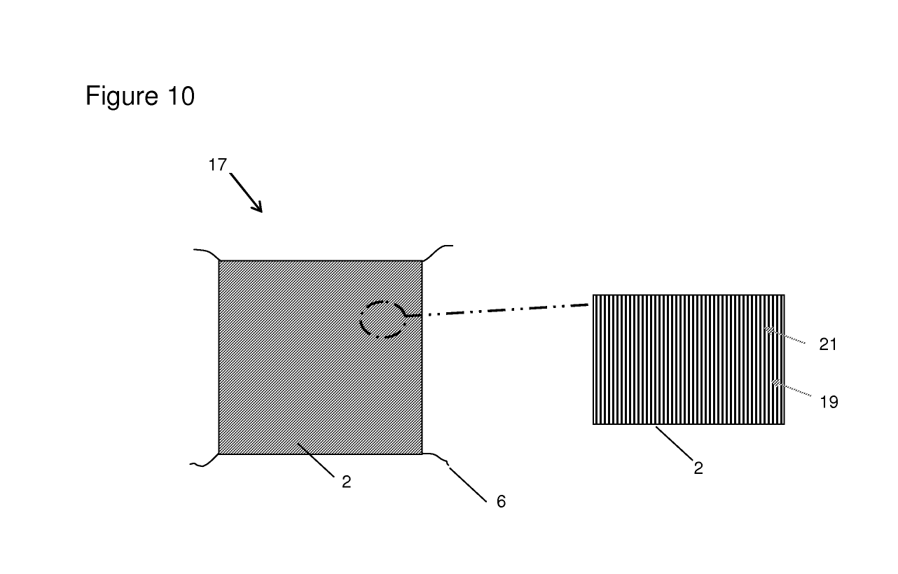

FIG. 10 illustrates an element 17 representing a third embodiment of the invention. This embodiment differs from the embodiment in FIG. 8 in that an alternative fine patterning is used for the conducting layer 2. In this case such patterning includes an array of fine conducting lines (representing reflective regions 19) with non-conducting gaps (representing optically transparent regions 21) in between. The conducting material forming the regions 19 should be electrically contiguous, for example using an electrically conductive trace along an edge(s) of the element 17 (e.g., along the upper and lower edges of the array). The pitch of such an array of fine conducting lines will typically be less than 1 micron and more typically of the order of 100 nm. Such an array will have the property that it will reflect plane polarised light with a polarisation axis parallel to the array, and transmit light polarised orthogonal to it. As such the array constitutes a “wire-grid” polariser and may function as a reflective polariser as is known in the art. Techniques for forming such a small-scale structure, such as laser interferometry, are also well known in the art. Such an element 17 therefore constitutes a combined reflective polariser and touch sensor.

It should be understood that such a pattern may equally be implemented with the macroscopic patterning into discrete isolated regions as previously described in the embodiment of FIG. 9. In this manner, the conducting layer 2 may be made up of an array of electrically isolated mini-grids each having an array of fine conducting lines 19 with non-conducting gaps 21 therebetween.

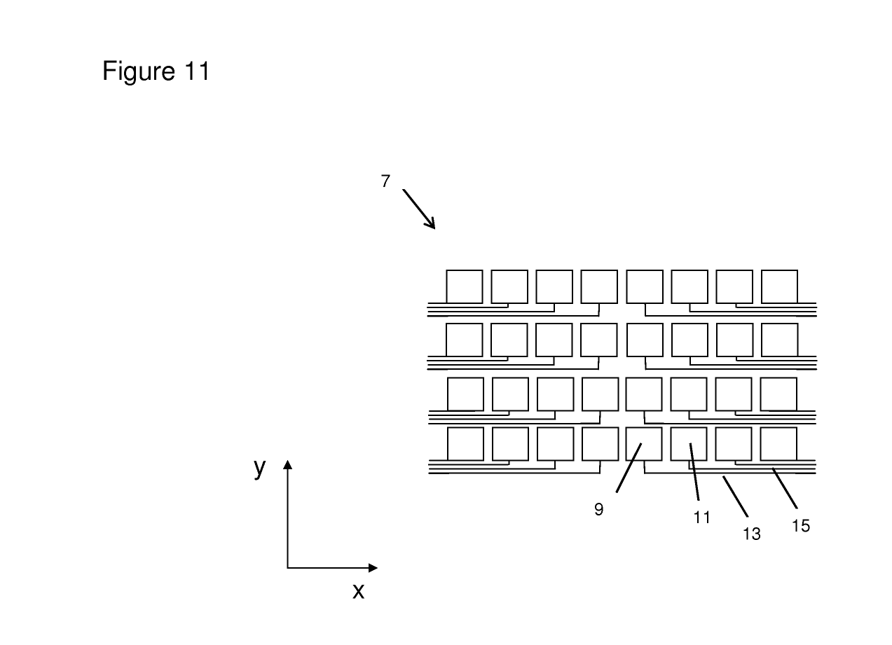

FIG. 11 illustrates a possible configuration of discrete regions within an element 7, as in an expanded embodiment of FIG. 9, in order to provide a touch sensor. A number of discrete touch regions (e.g., 9, 11) are represented by squares, with attached lines (e.g., 13, 15, respectively) showing the electrical connections which lead to the perimeter for connection to measurement equipment. A finger brought near to this array will register the strongest signal on the regions close to it. Comparison of signal strength at each of the attached lines may allow interpolation of position to an accuracy finer than the pitch of the array. Therefore, such an array may be used to allow location of a touch in x and y directions. This can be useful in use as a 2D touchscreen for display applications.

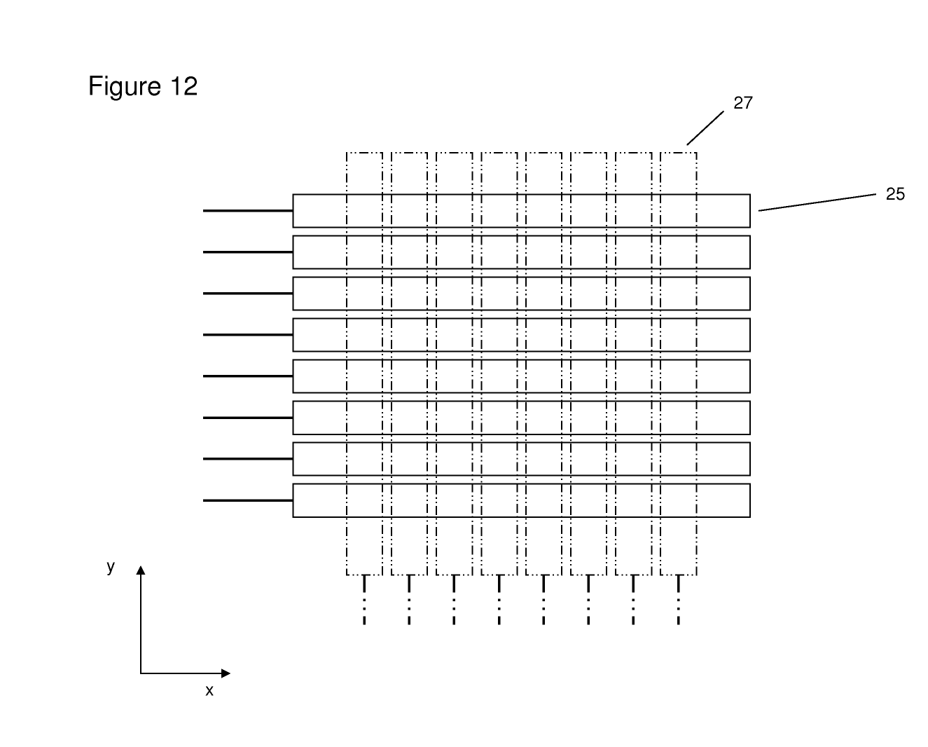

FIG. 12 illustrates a further possible configuration of discrete regions (e.g., 25, 27, etc.) within an element in order to provide a touch sensor. This differs from the embodiment of FIG. 11 in that discrete regions 25, 27, etc. are formed as rows and columns respectively on two separate optically transparent substrates (or on opposite faces of one substrate). One set of conductors in the form of regions 25 are for sensing in a y direction are formed on a first substrate, whilst a second set of regions 27 for sensing in an x direction are formed on a second substrate mounted below the first. Such an arrangement may have advantages of simplicity of connection tracks compared to that shown in FIG. 11 and therefore may allow a greater density of discrete regions and hence greater positional accuracy. Again the regions 25, 27, etc. may each comprise a conducting layer 2 with a pattern of regions 4, 5 as in FIGS. 8 and 9; regions 19, 21 as in FIG. 10; or any other suitable combination of electrically conductive and optically reflective regions, and optically transparent regions.

FIG. 13 illustrates an example of a touch sensor 30 according to the present invention. This example utilizes an optical element 1 of the type shown in FIG. 8, and a measurement technique commonly referred to “surface capacitance”. The optical element 1 including the conducting layer 2 which is electrically contiguous with electrical connections 6 at each corner. Only one such connection 6 is shown for clarity.

The method employs an AC source 31 which provides a drive signal to each corner. When a finger touches or comes in close contact with the conducting layer 2 it forms a capacitance allowing AC current to flow to ground. The resistance of the path between the finger and each corner of the element 1 will be proportional to the distance from that corner, so in general each resistance values 32, 34 from respective corners will be different. The current drawn from each corner will be proportional to said resistance and this may be amplified by amplifier 36 and measured by associated controller 38. The relative value of the four current measurements is used to determine the finger position. Such a technique is most suitable when the finger can be in close contact with the conducting layer 2.

FIG. 14 illustrates another example of a touch sensor 40 in accordance with the present invention. This example combines the basic electrical arrangement for a known measurement technique commonly called “projected capacitance” and an element 7 of the type shown in FIGS. 9 and 11 where the conductor is sub-divided into electrically isolated regions. For clarity just one such region 11 is illustrated, so it should be understood that multiple such regions may exist and each senses touch independently.

An AC source 42 is used to charge up reference capacitor 44. The conductor region 11 functions as a touch pad and forms some capacitance to ground represented by C_{touch} 46. If charging of the reference capacitor 44 is stopped then the voltage on it may be monitored whilst it discharges through C_{touch} 46. The value of said capacitance will determine the rate of discharge. The touch capacitor and the reference capacitor act as potential divider and the measured voltage is give by the following equation:

V_{measured}=V_{drive}·C_{ref}/(C_{ref}+C_{touch})

If a finger is brought close to the touchpad, the value of C_{touch} 46 will increase and this may be detected by a reduction in the measured voltage.

Other methods for measuring the change in capacitance produced by the presence of the finger are known to those skilled in the art. This may include techniques for improving accuracy and sensitivity and for reducing noise.

Such techniques have the advantage that a finger may be detected when it is in proximity but not touching the sensor, the signal increasing in strength as the finger approaches the sensor. This may be particular useful in systems where the physical arrangement of components restricts the ability to directly touch the sensor for example where the sensor is not located at or very close to the surface of the device.

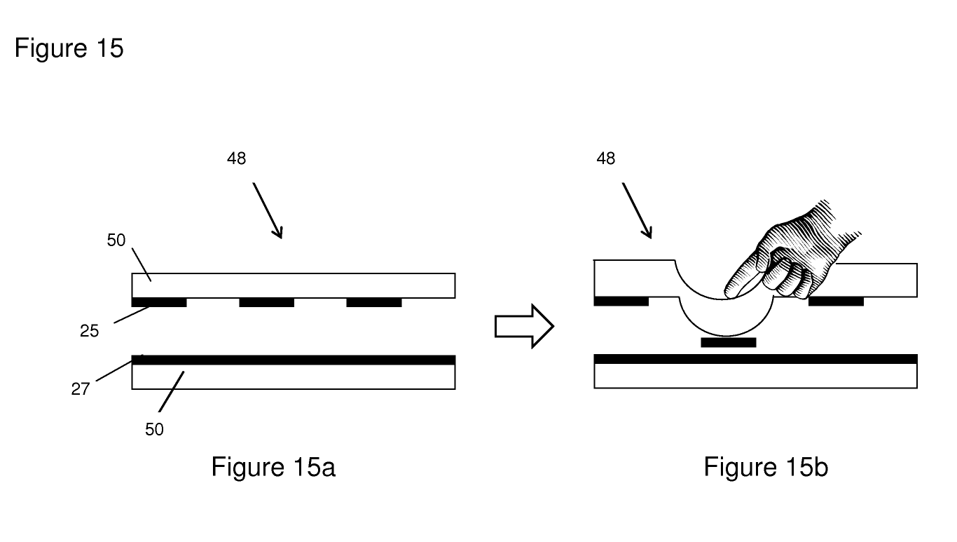

FIGS. 15a and 15b represent a touch sensor 48 in accordance with a fourth embodiment of the invention. The touch sensor 48 differs from the previously described touch sensor embodiments in that the conductors of the optical element are arranged to provide a resistive touch sensor. The optical element comprises optically transparent substrates 50, at least the upper one of which is deformable by touch. The patterned conductors 25 and 27 are formed on opposing faces of each substrate 50. They may typically have a pattern similar to that illustrated in FIG. 12 to give an array of intersecting points in two directions, with sub-patterning to give a partial mirror as described in previous embodiments. The resistance is measured between each conductor on the top substrate and each conductor on the lower substrate. When the upper substrate is deformed by the presence of a finger or other pointing device, the upper conductor at that location is brought closer to the lower conductor and the resistance between them will reduce. If all such resistances are monitored then the position of the finger may be deduced.

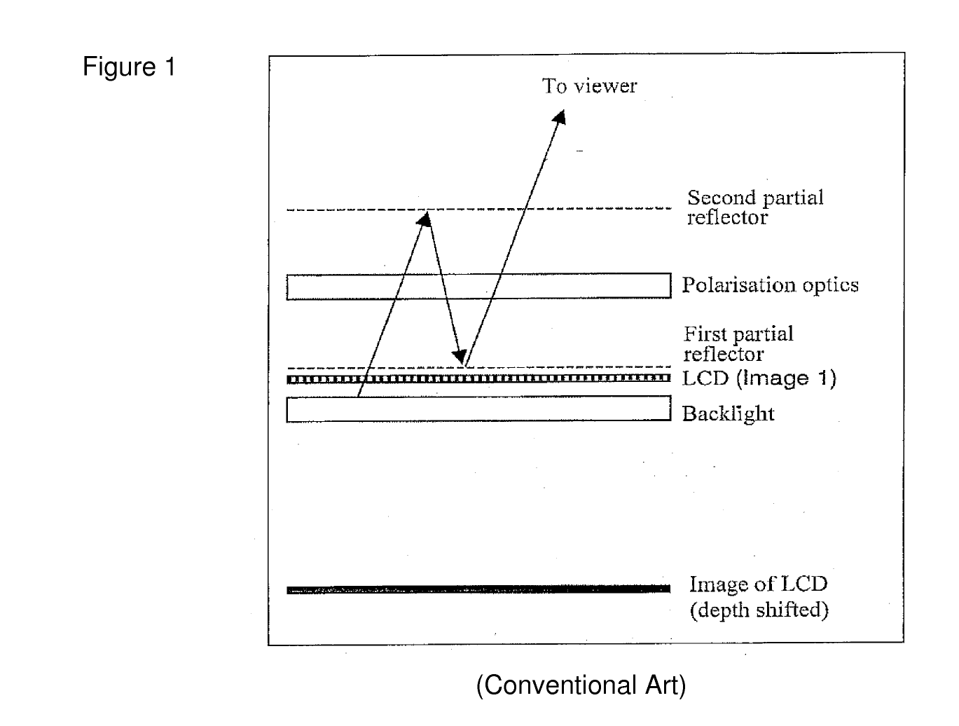

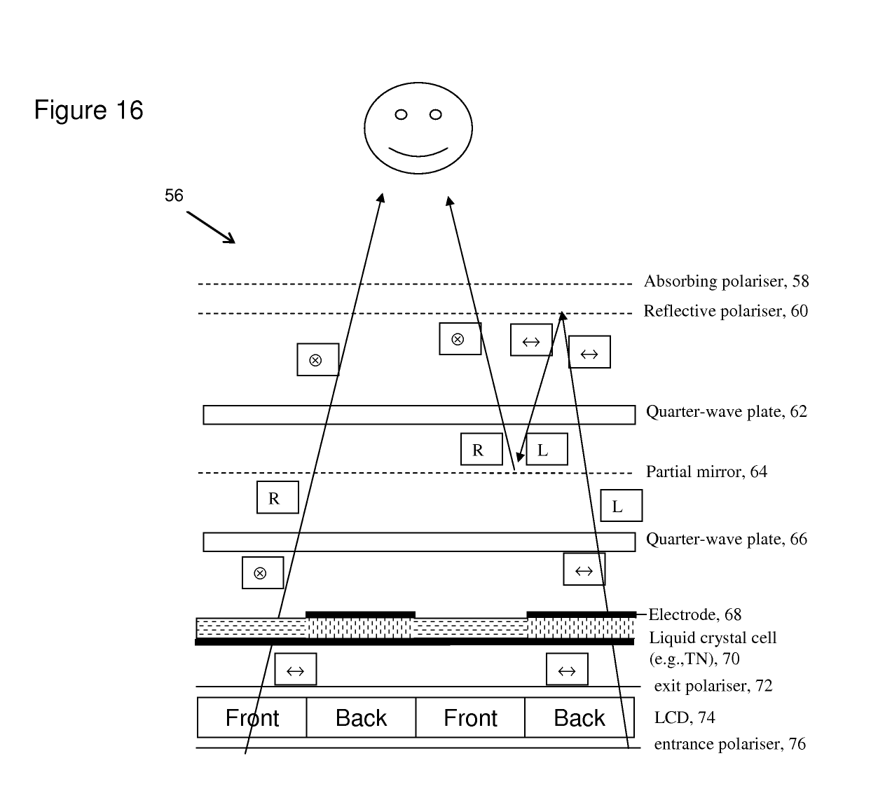

FIG. 16 illustrates a display system 56 incorporating a touch sensor in accordance with an exemplary embodiment of the present invention. The display system 56 is an example of a known type of multiple image depth display, as illustrated in FIG. 1, incorporating an optical element as described in any previous embodiments of the invention.

The system 56 includes, in order, an absorbing polariser 58, reflective polariser 60, quarter-wave plate 62, partial mirror 64, quarter-wave plate 66, electrode 68, liquid crystal cell 70, exit polariser 72, LCD 74 for forming an image, and entrance polariser 76. The specific operation of the system 56 with the exception of the use of an optical element as described herein is otherwise known and thus will not be described in detail herein for sake of brevity.

The system 56 is arranged to provide two different images from the LCD 74 in two different depth planes. Typically the reflective polariser 60 may consist of a multiple layer polymer stack known as a DBEF as is well known in the art. The partial mirror 64 is commonly a multiple layer thin film coating on glass or plastic. The properties of the film may be adjusted to give the required transmission and reflection properties. However, both these components are relatively expensive.

In this embodiment, the reflective polariser 60 is instead formed by the use a patterned conductor layer. This patterning is arranged to be in the form of a “wire grid” array as described above in relation to optical element 17 in FIG. 10, and as such will function as a reflective polariser. The optical element represented in FIG. 10 can be arranged to provide a polarised reflection function and a touch sensing function as described above. It is thus possible to achieve a multiple depth display with integrated touch function at reduced cost and thickness compared to separate components.

Any of the previously described measurement techniques to determine touch may be used, including surface capacitance, projected capacitance and resistive.

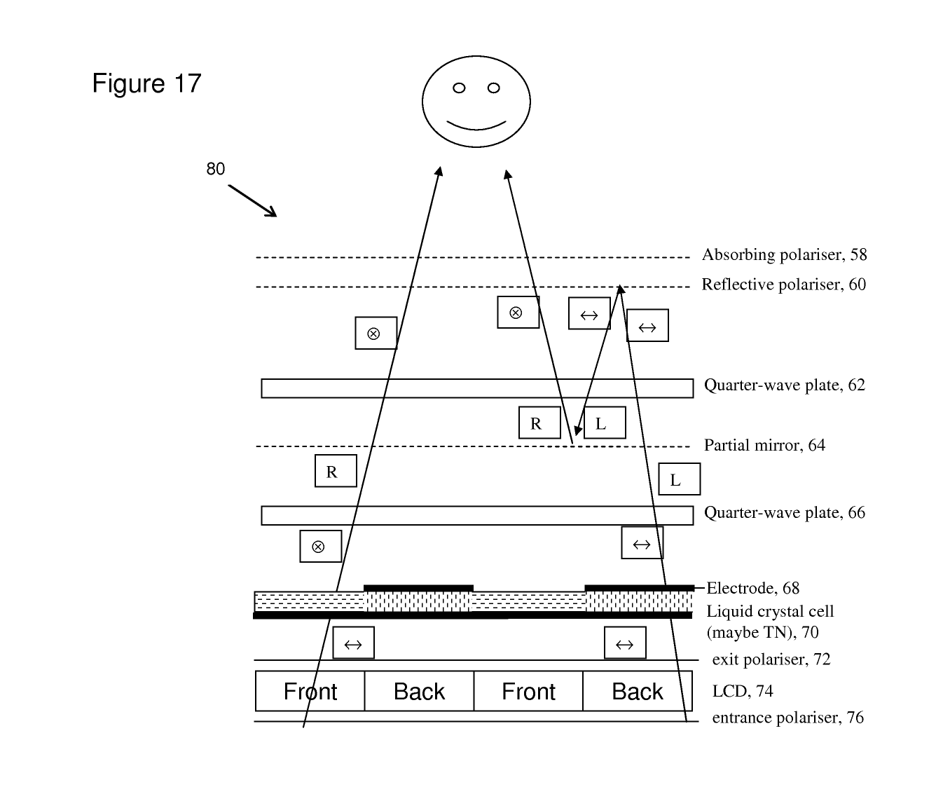

FIG. 17 illustrates a display system 80 incorporating an optical element and touch sensor in accordance with another embodiment of the invention. The display system 80 differs from that illustrated in FIG. 16 in that the reflective polariser 60 may be achieved by any typical method such as a DBEF. However, in this case an alternative form of the partial mirror 64 is used. In this case a patterned conductor, for example of the form of the optical element 7 in FIG. 9, is used to provide partial reflection and transmission. Thus, the partial mirror 64 may also be used to function as a touch sensor according to any of the previously described methods (e.g., as a touch sensor 40 as shown in FIG. 14). Therefore, the system 80 provides a further method to achieve a multiple depth display with integrated touch function at reduced cost and thickness compared to separate components.

Because the partial mirror 64 is required to be some distance below the top of the system 80 (in order to provide the depth effect) then it may be advantageous to use the “projected capacitance” method (e.g., as shown in FIG. 14) to achieve touch sensing as this does not require very close proximity of the finger. The presence of the ITO electrode in the LC cell 70 may also be beneficial in providing shield from noise from the LCD 34.

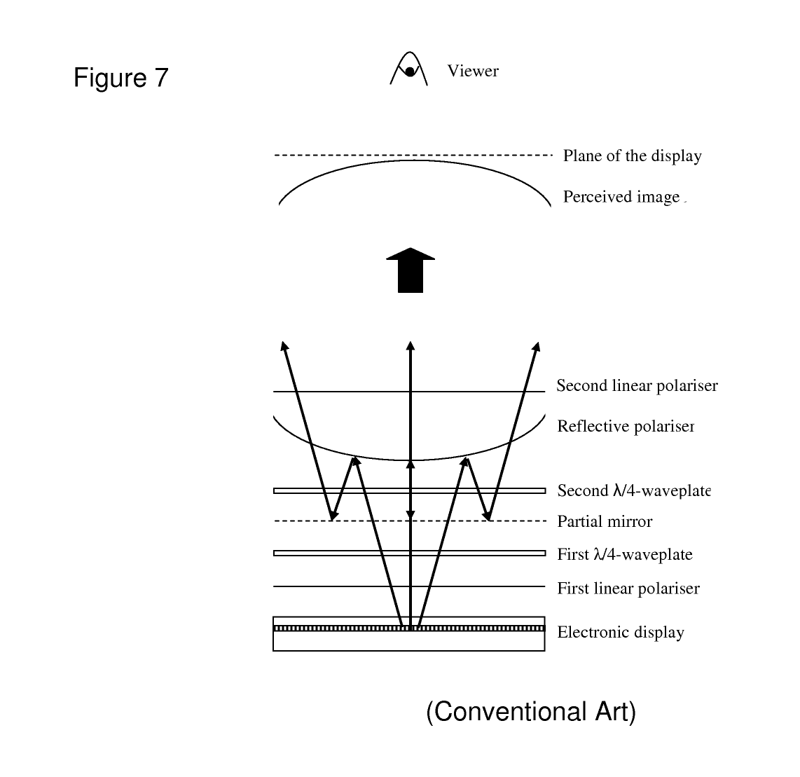

A seventh embodiment of the invention comprises a variation of the known curved-appearance display illustrated in FIG. 7. The display system uses a partial mirror and reflective polariser in a manner similar to those described in the previous two embodiments. The reflective polariser may be replaced by a conductor patterned to form a wire grid polariser (e.g., an optical element 17 as in FIG. 10) in a manner analogous to the embodiment of FIG. 16.

Alternatively the partial mirror may be replaced by a patterned conductor to provide partial reflection and transmission (e.g., an optical element 7 as in FIG. 9) in a manner analogous to the embodiment of FIG. 17. It is thus possible to achieve a curved-appearance display with integrated touch function at reduced cost and thickness compared to separate components.

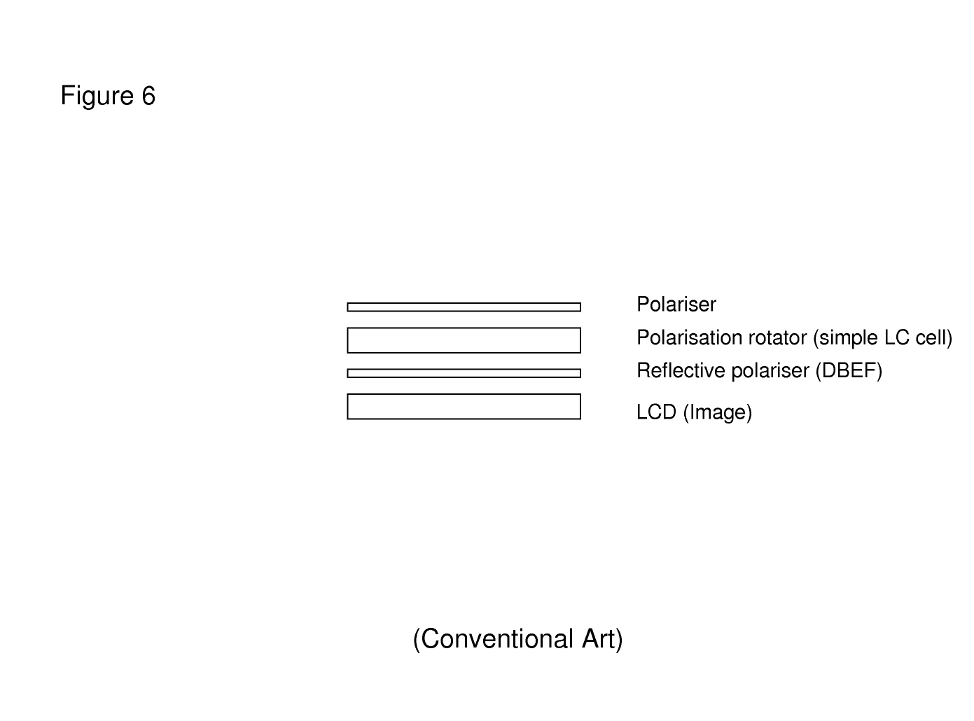

An eighth embodiment of the invention comprises a variation of the known switchable mirror display illustrated in FIG. 6. This system uses a reflective polariser, which is typically realised by the use of a DBEF. In this embodiment of the present invention, however, the reflective polariser is instead formed by the use a patterned conductor layer (e.g., as in FIG. 10). This patterning is arranged to be in the form of a “wire grid” array as described above, and as such will function as a reflective polariser. The conductor may also be arranged to provide a touch sensing function as described in previous embodiments. It is thus possible to achieve a switchable mirror display with integrated touch function at reduced cost and thickness compared to separate components.

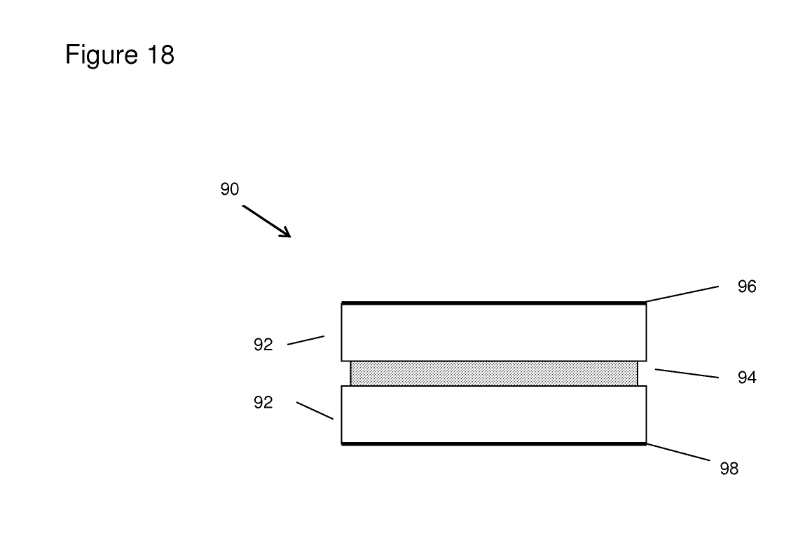

FIG. 18 illustrates a display system 90 constituting a ninth embodiment of the invention. It represents a standard LCD comprising substrates 92, liquid crystal 94 and polarisers 96 and 98. Typically the polarisers would be formed from a stretched polymer containing a dichroic dye such as iodine. In this embodiment either of the polarisers 96 and 98 may be replaced by an element 17 as illustrated in FIG. 10 which will function as a reflective polariser and touch sensor. As such this system 90 constitutes a display with integrated touch sensor. It may be particularly advantageous to arrange for such an element to form the lower polariser 98. In ambient lighting conditions this system will naturally function as a reflective display with integrated touch sensor, with no further reflector required. In the case of illumination provided from a backlight behind the display, the incorrect polarised would be reflected back to the backlight and recycled, thus improving optical efficiency. Thus a display with integrated touch sensor may be provided with reduced cost and thickness compared to an additional touch sensor.

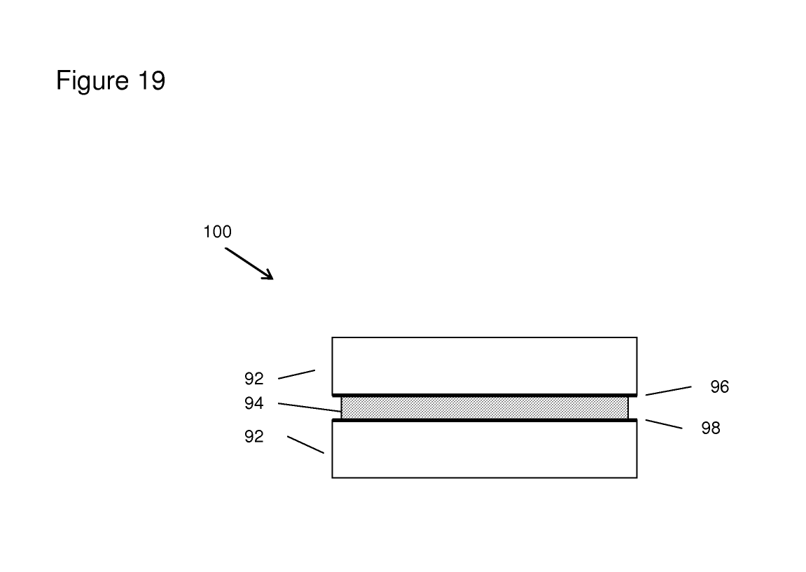

FIG. 19 illustrates a display system 100 constituting a ninth embodiment of the invention. This embodiment differs from that in FIG. 18 in that the one or more reflective polarisers 96 and 98 are formed in the inner surface of the substrate. This may be advantageous in simplifying the fabrication process. Also, in the case that the lower polariser 98 is formed from such a touch sensor element as in FIG. 10, then the resulting reflective display may reduce image parallax artefacts.

In all of the above embodiments the conducting layer 2 has been spatially patterned to provide partial reflection and partial transmission by virtue of the proportion of area covered by conductor. The thickness of the conducting layer 2 is such as to substantially reflect all of the light. Alternatively a very thin conducting layer 2 may be used covering the whole substrate. For example, an aluminium layer of approximately 5 nm in thickness will transmit ˜50% and reflect ˜50%. The conducting layer 2 may be uniform across the underlying substrate as in the embodiments of FIGS. 8 and 13, or divided into electrically isolated regions as in the embodiments of FIGS. 9 and 14, for example.

Although the invention has been shown and described with respect to certain preferred embodiments, it is obvious that equivalents and modifications will occur to others skilled in the art upon the reading and understanding of the specification. For example, while the optical element as described above includes conductive regions which are reflective and non-conductive regions which are transparent, other embodiments may be used. In another embodiment, conductive regions may be transparent (e.g., through the use of indium-tin-oxide (ITO)) and non-conductive regions may be reflective (e.g., through the use of non-conducting reflective materials, conducting materials electrically isolated via an isolation layer, etc.)

The present invention includes all such equivalents and modifications, and is limited only by the scope of the following claims.

1. A touch sensor for a touch display, comprising:
an optical element including at least one electrically conductive layer, the at least one electrically conductive layer being partially reflective and partially transmissive with respect to incident light; and
sensing circuitry electrically coupled to the at least one electrically conductive layer to determine positioning of a finger, hand or other type of pointing device relative to the optical element.

2. The touch sensor of claim 1, wherein the at least one electrically conductive layer comprises a randomized pattern of conducting regions and non-conducting regions.

3. The touch sensor of claim 1, wherein the at least one electrically conductive layer comprises a regular array of conducting and non-conducting lines.

4. The touch sensor of claim 3, wherein the array has a pitch which is less than 1 micron.

5. The touch sensor of claim 3, wherein the optical element reflects plane polarized light with an axis parallel to the array, and transmits light polarized orthogonal to the array.

6. The touch sensor of claim 1, wherein the at least one electrically conductive layer is electrically contiguous across an entire area of the at least one electrically conductive layer.

7. The touch sensor of claim 1, wherein the at least one electrically conductive layer is subdivided into regions electrically isolated from each other.

8. The touch sensor of claim 7, wherein the subdivided regions are arranged in a regular array or comprise multiple arrays on multiple layers in parallel planes electrically isolated from each other.

9. The touch sensor of claim 1, wherein the optical element functions as a reflective polariser.

10. The touch sensor of claim 1, wherein the transmittance and reflectance of the at least one electrically conductive layer are each within the range of 0.2 to 0.8.

11. The touch sensor of claim 1, wherein the transmittance and reflectance of the at least one electrically conductive layer are each within the range of 0.4 to 0.6.

12. The touch sensor of claim 1, wherein the sensing circuitry is configured to determine position by measuring current with respect to a plurality of different reference locations on the electrically conductive layer.

13. The touch sensor of claim 1, wherein the sensing circuitry is configured to determine position by monitoring a capacitance of each of a plurality of electrically isolated regions in the at least one electrically conductive layer.

14. The touch sensor of claim 1, wherein the optical element comprises first and second electrically conductive layers in parallel planes electrically isolated from each other, each of the first and second electrically conductive layers being subdivided into regions electrically isolated from each other, and the sensing circuitry is configured to determine the position by monitoring at least a capacitance or resistance associated with each of the electrically isolated regions.

15. A touch display system, comprising:
an image device for providing an image; and
a touch sensor in accordance with claim 1 operatively combined with the image device.

16. The touch display system of claim 15, wherein the optical element is operative in creating multiple image planes.

17. The touch display system of claim 15, wherein the optical element is operative in creating a curved image plane.

18. The touch sensor of claim 1, wherein the at least one electrically conductive layer comprises a spatially-patterned metallic layer.

19. The touch sensor of claim 1, wherein the at least one electrically conductive layer comprises a metallic layer sufficiently thin so as to have a transmittance and reflectance each within the range of 0.4 to 0.6.
